(19) United States
(12) Patent Application Publication
(10) Pub. No.: US 2016/0337299 A1
(43) Pub. Date: Nov. 17, 2016

(54) PRIORITIZED NOTIFICATION DISPLAY

(71) Applicant: Google Inc., Mountain View, CA (US)

(72) Inventors: Joshua LANE, Brooklyn, NY (US); Balaji SRINIVASAN, Fremont, CA (US); Josh OLDMEADOW, Sunnyvale, CA (US)

(73) Assignee: Google Inc., Mountain View, CA (US)

(21) Appl. No.: 14/710,732

(22) Filed: May 13, 2015

(51) Int. Cl. H04L 12/58; H04L 29/08

(52) U.S. Cl. CPC H04L 51/26; H04L 67/10

(57) ABSTRACT

Systems, methods and computer readable media for prioritized notification display are described. Some implementations can include a method. The method can include receiving a notification, and determining a priority score of the notification. When the notification is determined to have a priority equal to or greater than a given value, the method can also include causing the notification to be displayed individually in a user interface. The method can further include causing the notification to be displayed as a portion of a deck element in the user interface when the notification is determined to have a priority less than the given value.

### BACKGROUND

Notifications may originate from various sources (e.g., mobile applications, communication services, social networks and the like) and can be used to indicate events, status changes, new messages, social network updates or the like. These notifications can appear on one or more devices associated with corresponding user accounts.

### SUMMARY

Some implementations relate generally to notifications, and more particularly to systems, methods and computer readable media for prioritized notification display.

Some implementations can include a method. The method can include receiving, at one or more processors, a notification, and determining, using the one or more processors, a priority score of the notification.

When the notification is determined to have a priority score equal to or greater than a given value, the method can also include causing, using the one or more processors, the notification to be displayed individually in a user interface. The method can further include causing, using the one or more processors, the notification to be displayed as a portion of a deck element in the user interface when the notification is determined to have a priority score less than the given value.

In some implementations, determining the priority score of the notification can include determining a source of the notification. In some implementations, determining a priority score of the notification can include determining whether a sending account of a message that is a subject of the notification has a social affinity score with a recipient account of the notification above a given social affinity score value.

The method can also include creating a new deck element associated with the corresponding source and adding the notification to the new deck element, when the notification is determined to have a priority score less than the given value and the notification is a first notification in a current notification list for a corresponding source. The method can further include adding the notification to an existing deck element associated with the corresponding source, when the notification is determined to have a priority score less than the given value and the notification is not a first notification in a current notification list for a corresponding source.

In some implementations, the notification can be added to a top of the existing deck element. In some implementations, the notification can be added to a bottom of the existing deck element. The method can also include causing the deck element in the user interface to be displayed as a number of individual notifications in an expanded deck element when an indication is received that the deck element has been selected. The method can further include causing all of the individual notifications within the deck element to be displayed when an indication is received that a show all element of the expanded deck element has been selected.

Some implementations can include a system comprising one or more computers configured to perform operations. The operations can include receiving a notification, and determining a priority score of the notification. The operations can also include causing the notification to be displayed individually in a user interface when the notification is determined to have a priority score equal to or greater than a given value. The operations can further include causing the notification to be displayed as a portion of a deck element in the user interface when the notification is determined to have a priority score less than the given value.

In some implementations, determining the priority score of the notification can include determining a source of the notification. In some implementations, determining the priority score of the notification can include determining whether a sending account of a message that is a subject of the notification has a social affinity score with a recipient account of the notification equal to or greater than a given value.

The operations can also include creating a new deck element associated with the corresponding source and adding the notification to the new deck element when the notification is determined to have a priority score less than the given value and the notification is a first notification in a current notification list for a corresponding source. The operations can further include adding the notification to an existing deck element associated with the corresponding source when the notification is determined to have a priority score less than the given value and the notification is not a first notification in a current notification list for a corresponding source.

The operations can also include causing the deck element in the user interface to be displayed as a number of individual notifications in an expanded deck element when an indication is received that the deck element has been selected, and causing all of the individual notifications within the deck element to be displayed when an indication is received that a show all element of the expanded deck element has been selected.

Some implementations can include a nontransitory computer readable medium having stored thereon software instructions that, when executed by a processor, cause the processor to perform operations. The operations can include receiving a notification, and determining a priority score of the notification.

The operations can also include causing the notification to be displayed individually in a user interface when the notification is determined to have a priority score equal to or greater than the given value. The operations can further include causing the notification to be displayed as a portion of a deck element in the user interface when the notification is determined to have a priority score less than the given value.

In some implementations, determining the priority score of the notification can include determining a source of the notification. In some implementations, determining the priority score of the notification can include determining whether a sending account of a message that is a subject of the notification has a social affinity score with a recipient account of the notification above a given social affinity score value.

The operations can also include creating a new deck element associated with the corresponding source and adding the notification to the new deck element when the notification is determined to have a priority score less than the given value and the notification is a first notification in a current notification list for a corresponding source. The operations can further include adding the notification to an existing deck element associated with the corresponding source when the notification is determined to have a priority score less than the given value and the notification is not a first notification in a current notification list for a corresponding source.

### BRIEF DESCRIPTION OF THE DRAWINGS

FIG. 1 shows a diagram of an example user interface for prioritized notification display in accordance with some implementations.

FIG. 2 shows a diagram of an example user interface for prioritized notification display in accordance with some implementations.

FIG. 3 is a flow chart of an example prioritized notification display process in accordance with some implementations.

FIG. 4 is a flow chart of an example prioritized notification display process in accordance with some implementations.

FIG. 5 is a diagram of an example computing device configured for prioritized notification display in accordance with some implementations.

### DETAILED DESCRIPTION

Users may frequently receive notifications from various applications on phones and computers. Some of the notifications may have a higher priority (e.g., may be important), while some of the notifications may have a lower priority (e.g., may not be important). For example, a user's spouse sending the user a message would typically have a higher priority than a stranger commenting on a user's photo on a social network. Some existing notification display systems may not provide much, if any, visual difference or distinction between notifications having different priority scores (e.g., important and unimportant notifications). Some implementations provide a user interface that more clearly distinguishes between notifications having different priority scores. It will be appreciated that while two priority levels (e.g., high and low) are described herein for illustration purposes, an implementation could include any number of priority levels.

In general, some implementations provide a computer interface that is configured to display notifications of different priority score values in distinct ways. Notifications having a priority score equal to or greater than a given value can be displayed as individual cards (or notification elements). Notifications having a priority score less than a given value can be grouped together and displayed as a stack (or deck) of cards. When a user selects (e.g., clicks or touches) the deck element, the deck can be expanded outward visually on a display to reveal each individual notification.

Notifications can be used to indicate events, status changes, new messages, social network updates, calendar alarms or the like. Notifications can be received at a device (e.g., smart phone, tablet, wearable computing device or the like) from an application within the device (e.g., “push” notifications from a mobile application (or app) running within the device), from an application or system external to the device or from a combination of the above. Some device operating systems may not require an application associated with the notification to be open (or running) in order to display the notification.

Some notifications can include a push notification in which the sender of the notification initiates the message or notification sent to a client device. Other notifications can include pull notifications in which a request is initiated by a client device (e.g., a user device) and the notification is associated with a response to the request. Notifications can also be generated automatically in response to an occurrence of one or more events (e.g., establishing a connection to a wireless network or the like).

Generally, a notification can include a message displayed on a user device outside of the normal user interface (UI) are of an application associated with the notification. When a system receives a request to issue a notification, the notification may first appear as an icon in a notification area. In some systems, the details of the notification can be viewed in a notification drawer. Both the notification area and the notification drawer are typically system-controlled areas that a user can view at any time.

Receipt of notifications may be controlled by settings associated with the device or with the application or service generating the notifications. However, in some systems, all notifications that are received according to the notification settings may be displayed in a similar way. Thus, a high priority (or important) notification (e.g., a notification of a new message from a sender in a user's contact list) may be displayed alongside one or more notifications from a game application or from a social network indicating an update that may be of a relatively low priority (or unimportant) nature. Accordingly, notification lists in the notification drawer (or in other similar display areas) may include a combination of relatively high priority notifications along with relatively low priority notifications that a user may have to visually sort through.

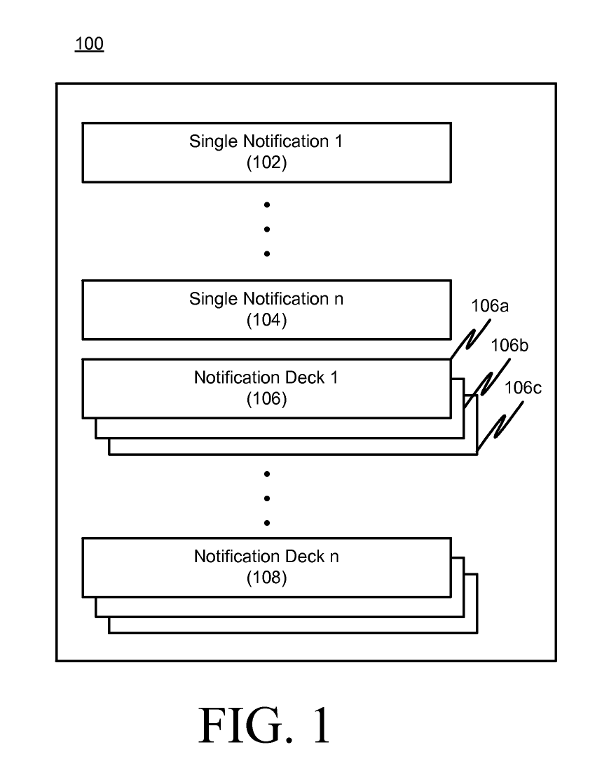

FIG. 1 shows a diagram of an example user interface 100 for prioritized notification display in accordance with some implementations. The user interface (UI) 100 includes a plurality of individually displayed notifications 102-104 (e.g., notifications having a priority score equal to or greater than a given value) and a plurality of notifications displayed in elements having a deck of cards metaphor as “deck” elements 106-108 (e.g., notifications having a priority score less than the given value). As shown in FIG. 1, the deck elements 106-108 are shown in a “collapsed” mode in which one or more of the notifications (or notification images) in the deck are at least partially hidden below (or obscured by) a topmost image of a notification in the deck. The individual notifications or deck elements can include a summary or digest of a notification with one or more items of information from the notification (e.g., source application, date/time, abstract or first few words or lines of notification message, or the like).

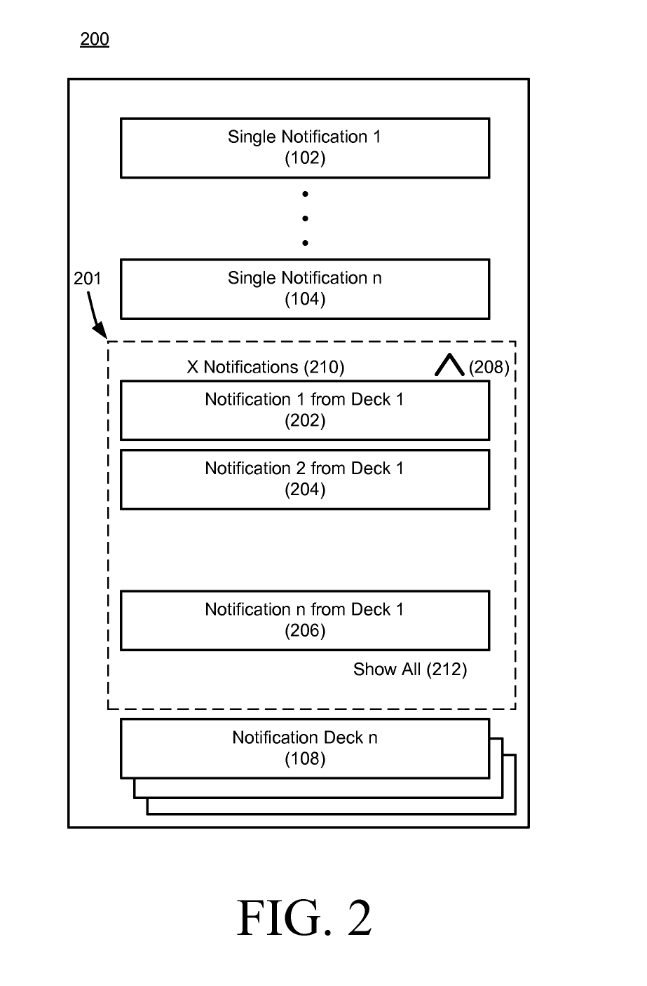

It will be appreciated that a plurality of individually displayed notifications and a plurality of deck notification elements are shown in FIGS. 1 and 2 for illustration purposes and that an actual prioritized notification display user interface can include more or less of each notification type depending on the type and quantity of notifications present in the system at a particular time. Also, it will be appreciated that the prioritized notification display can be dynamically and automatically updated over time in response to one or more events (e.g., new notifications being received, notifications being viewed by a user or the like, notifications being removed (automatically or manually) or the like). A system can check periodically for events and update the prioritized notification display in response to any detected events and/or the system can respond to events as they occur to update the prioritized notification display.

Some implementations can provide an advantage for a user to see or visualize higher priority notifications on a display device with more prominence than lower priority notifications. By grouping higher priority notifications together, some implementations can lessen the number of lower priority notifications displayed on a device screen. For example, if there are 10 high priority notifications and 16 low priority notifications, to a user viewing an implementation of the prioritized notification display user interface, the notifications will appear as 10 high priority notifications and 1 stack of low priority notifications. By grouping low priority notifications, some implementations can help reduce visual distraction of low priority notifications and conserve screen area for higher priority notifications.

FIG. 2 shows a diagram of an example user interface 200 for prioritized notification display in accordance with some implementations. In the user interface 200, a notification deck element (Notification Deck 1, 106 shown in FIG. 1) has been selected and has been displayed as an expanded deck 201. The deck notification element has been expanded to display individual notifications (202-206) from Notification Deck 1 (106 in FIG. 1).

In addition to the individual notifications, the expanded deck 201 also includes a minimization element 208, an element indicating the number of notifications in the deck 210 and an element to show all notification in the deck 212.

When the minimization element 208 is selected, the expanded deck is collapsed back into a collapsed deck mode (e.g., 106 in FIG. 1). The number of notifications in the deck element 210 provides a visual indication of the total number of notifications in the deck. A display of the number of notifications can be helpful when a device displays only a portion of the individual notifications in an expanded deck on the screen of the device. The number of individual notifications shown may be limited in order to conserve screen area (e.g., for displaying other user interface elements such as other individual or deck notifications).

When the show all element 212 is selected, a full list of the individual notifications in the expanded deck can be displayed. The full list may need to be a scrollable list in order to accommodate the total number of notifications, which may not fit on one page area of the device screen. Selecting an individual notification can cause the notification to be displayed in full detail or for the notification to be opened in an application associated with the notification.

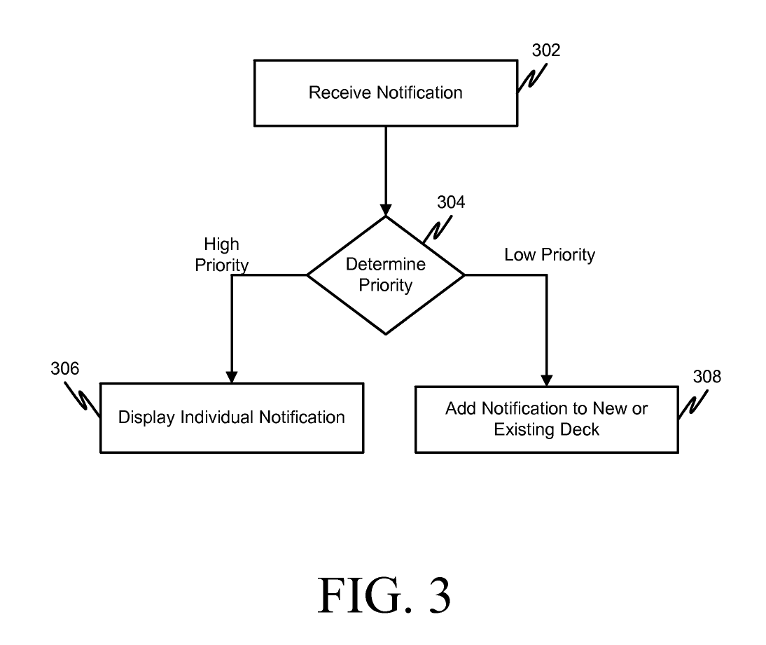

FIG. 3 is a flow chart of an example prioritized notification display process in accordance with some implementations. Processing begins at 302, where a notification is received. A notification may indicate one or more events, status changes, new messages, social network updates, calendar alarms or the like. Notifications can be received at a device (e.g., smart phone, tablet, wearable computing device or the like) from an application within the device (e.g., a “push” notification from a mobile application (or app) running within the device), from an application or system external to the device or from a combination of the above. Processing continues to 304.

At 304, a priority score of the notification is determined. Priority score determination can be based on one or more factors, settings, or the like. For example, certain notification sources (e.g., applications, social networks, software services or the like) may be designated as high priority notification sources and certain notification sources may be designated as low priority notification sources. Designations of whether a notification source is a high priority notification source may be stored within a user device, a notification server, or both. Notifications received from a source designated as a high priority notification source may be displayed as high priority notifications (e.g., displayed individually) while notifications received from a source designated as a low priority source may be displayed as low priority notifications (e.g., displayed as part of a deck element).

Information used to determine notification priority score can include one or more of notification source (e.g., application, social network service, other software service, or the like), user (or user account) associated with a notification, time/date of notification, notification subject, social affinity between users associated with sending and receiving the notification (e.g., a user sending a message to their spouse), or the like. Priority score can be automatically determined using information associated with a notification, for example, criteria such as number or frequency of interaction between a user and an application, social network, other user or the like. Notification priority can also be based on manual settings or selections from a user. For example, a user may desire to have notifications from a particular social network appear as high priority notifications and may provide a setting value indicating that notifications from that particular social network are to be treated as high priority for notification display purposes. If the notification is determined to be high priority, processing continues to 306. If the notification is determined to be low priority, processing continues to 308.

At 306, the high priority notification is displayed as an individual notification.

At 308, the low priority notification is displayed as part of a new or existing deck element of low priority notifications. It will be appreciated that 302-308 can be repeated in whole or in part in order to accomplish a contemplated prioritized notification display task. In some implementations, a notification priority can be determined (e.g., a priority score can be generated) using one or more of the factors described above. One or more notifications can be ranked relative to each other based on priority score. A given number of higher ranking notifications can be treated as high priority, while remaining notifications can be treated as low priority.

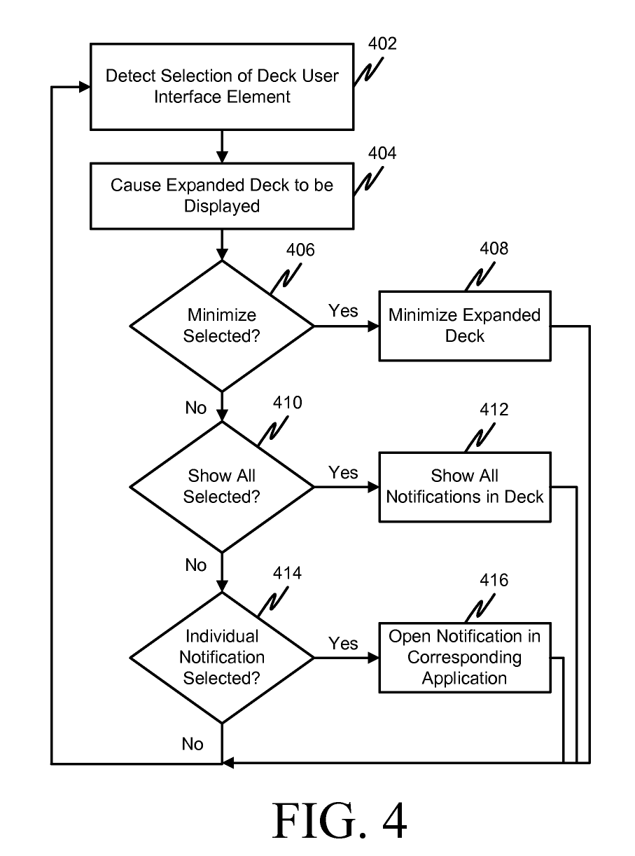

FIG. 4 is a flow chart of an example prioritized notification display process in accordance with some implementations. Processing begins at 402, where selection of a deck user interface element is detected. Selection could be detected by a click or touch event associated with the deck user interface element. Processing continues to 404.

At 404, an expanded deck is caused to be displayed. The expanded deck (e.g., 201) can show some or all of the notifications contained within the deck. The number of notifications displayed in the expanded deck can be based on the number of other notifications being displayed and any notification display parameters (e.g., a number of notifications to display at one time) within the notification display module or application. Processing continues to 406.

At 406, it is determined whether the minimize control has been selected. When the minimize control is selected, processing continues to 408. Otherwise, processing continues to 410.

At 408, the expanded deck associated with the minimize control is collapsed back to a non-expanded deck (e.g., 106 or 108). Processing continues to 402.

At 410, it is determined whether a show all notifications element has been selected. When the show all notifications element has been selected, processing continues to 412. Otherwise, processing continues to 414.

At 412, all notifications within a deck are displayed. When the number of notifications being displayed exceeds the viewable area of a device screen, a scrollable display element containing the notifications can be displayed. Processing continues to 402.

At 414, it is determined whether an individual notification has been selected. When an individual notification has been selected, processing continues to 416. Otherwise processing continues back to 402.

At 416, the selected individual notification is opened directly for full display or opened within an application associated with the selected individual notification. Processing continues to 402.

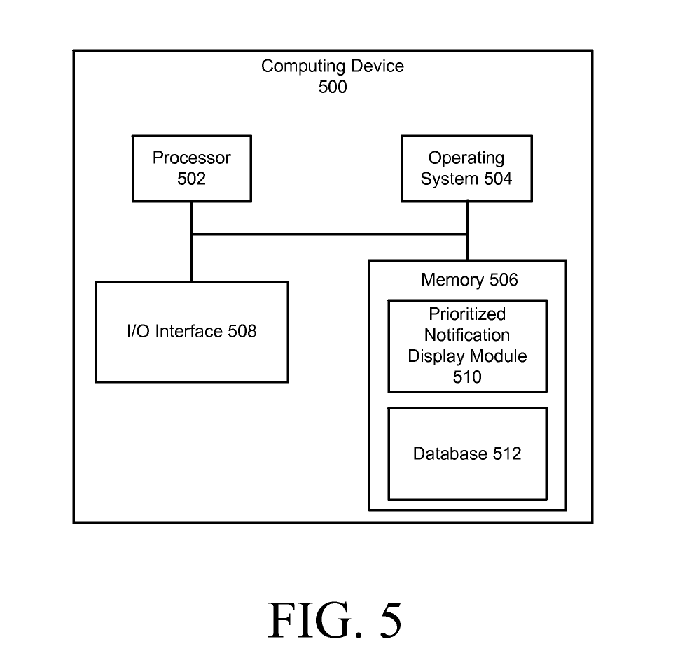

FIG. 5 is a diagram of an example computing device (e.g., server or user device) 500 that can be configured for prioritized notification display in accordance with some implementations. The computing device 500 includes a processor 502, operating system 504, memory 506 and I/O interface 508. The memory 506 can include a prioritized notification display module (or application) 510 and a database 512.

In operation, the processor 502 may execute the prioritized notification display module 510 stored in the memory 506. The prioritized notification display module 510 can include software instructions that, when executed by the processor, cause the processor to perform operations for prioritized notification display in accordance with the present disclosure (e.g., the prioritized notification display module 510 can cause the processor to perform one or more of steps 202-208 and 302-310 described above and, in conjunction, can access the database 512). The prioritized notification display module 510 can also operate in conjunction with the operating system 504.

The computing device (e.g., 500) can include, but is not limited to, a single processor system, a multi-processor system (co-located or distributed), a cloud computing system, or a combination of the above.

The client (or user) device(s) can include, but are not limited to, a desktop computer, a laptop computer, a portable computer, a tablet computing device, a smartphone, a feature phone, a personal digital assistant, a media player, a television, a video display device, an electronic book reader, an entertainment system of a vehicle or the like. Also, user devices can include wearable computing devices (e.g., glasses, watches and the like), furniture mounted computing devices and/or building mounted computing devices.

Some user devices can be connected to a notification system via a network. The network connecting user devices to the notification system can be a wired or wireless network, and can include, but is not limited to, a WiFi network, a local area network, a wide area network, the Internet, or a combination of the above.

The data storage, memory and/or computer readable medium can be a nontransitory medium such as a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Moreover, some implementations of the disclosed method, system, and computer readable media can be implemented in software (e.g., as a computer program product and/or nontransitory computer readable media having stored instructions for monochromatic image determination as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for prioritized notification display.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
receiving, at one or more processors, a notification;
determining, using the one or more processors, a priority score of the notification;
when the notification is determined to have a priority score equal to or greater than a given value, causing, using the one or more processors, the notification to be displayed individually in a user interface; and
when the notification is determined to have a priority score less than the given value, causing, using the one or more processors, the notification to be displayed as a portion of a deck element in the user interface.

2. The method of claim 1, wherein determining the priority score of the notification includes determining a source of the notification.

3. The method of claim 1, wherein determining the priority score of the notification includes determining whether a sending account of a message that is a subject of the notification has a social affinity score with a recipient account of the notification above a given social affinity value.

4. The method of claim 1, further comprising:
when the notification has a priority score less than the given value and the notification is a first notification in a current notification list for a corresponding source, creating, using the one or more processors, a new deck element associated with the corresponding source; and
adding, using the one or more processors, the notification to the new deck element.

5. The method of claim 1, further comprising:
when the notification has a priority score less than the given value and the notification is not a first notification in a current notification list for a corresponding source, adding, using the one or more processors, the notification to an existing deck element associated with the corresponding source.

6. The method of claim 5, wherein the notification is added to a top of the existing deck element.

7. The method of claim 5, wherein the notification is added to a bottom of the existing deck element.

8. The method of claim 1, further comprising:
causing the deck element in the user interface to be displayed as a number of individual notifications in an expanded deck element when an indication is received that the deck element has been selected.

9. The method of claim 8, further comprising:
causing all of the individual notifications within the deck element to be displayed when an indication is received that a show all element of the expanded deck element has been selected.

10. A system comprising one or more computers configured to perform operations including:
receiving a notification;
determining a priority score of the notification;
when the notification is determined to have a priority score equal to or greater than a given value, causing the notification to be displayed individually in a user interface; and
when the notification is determined to have a priority score less than the given value, causing the notification to be displayed as a portion of a deck element in the user interface.

11. The system of claim 10, wherein determining the priority score of the notification determining a source of the notification.

12. The system of claim 10, wherein determining the priority score of the notification includes determining whether a sending account of a message that is a subject of the notification has a social affinity score with a recipient account of the notification above a given social affinity score value.

13. The system of claim 10, wherein the operations further comprise:
when the notification is determined to have a priority score less than the given value and the notification is a first notification in a current notification list for a corresponding source, creating a new deck element associated with the corresponding source; and
adding the notification to the new deck element.

14. The system of claim 10, wherein the operations further comprise:
when the notification is determined to have a priority score less than the given value and the notification is not a first notification in a current notification list for a corresponding source, adding the notification to an existing deck element associated with the corresponding source.

15. The system of claim 10, wherein the operations further comprise:
causing the deck element in the user interface to be displayed as a number of individual notifications in an expanded deck element when an indication is received that the deck element has been selected; and
causing all of the individual notifications within the deck element to be displayed when an indication is received that a show all element of the expanded deck element has been selected.

16. A nontransitory computer readable medium having stored thereon software instructions that, when executed by a processor, cause the processor to perform operations including:
receiving, at one or more processors, a notification;
determining, using the one or more processors, a priority score of the notification;
when the notification is determined to have a priority score equal to or greater than a given value, causing, using the one or more processors, the notification to be displayed individually in a user interface; and
when the notification is determined to have a priority score less than the given value, causing, using the one or more processors, the notification to be displayed as a portion of a deck element in the user interface.

17. The nontransitory computer readable medium of claim 16, wherein determining the priority score of the notification includes determining a source of the notification.

18. The nontransitory computer readable medium of claim 16, wherein determining the priority score of the notification includes determining whether a sending account of a message that is a subject of the notification has a social affinity with a recipient account of the notification above a given value.

19. The nontransitory computer readable medium of claim 16, wherein the operations further comprise:
when the notification is determined to have a priority less than the given value and the notification is a first notification in a current notification list for a corresponding source, creating a new deck element associated with the corresponding source; and
adding the notification to the new deck element.

20. The nontransitory computer readable medium of claim 16, wherein the operations further comprise:
when the notification is determined to have a priority less than the given value and the notification is not a first notification in a current notification list for a corresponding source, adding the notification to an existing deck element associated with the corresponding source.
